(19) United States
(12) Patent Application Publication
(10) Pub. No.: US 2015/0213204 A1
(43) Pub. Date: Jul. 30, 2015

(54) DUAL SMART CARD E-PRESCRIPTION SYSTEM AND METHOD

(71) Applicant: MS Card Central Corp., New York, NY (US)

(72) Inventors: Surja Bose, Berlin (DE); Walter Cruz, Berlin (DE)

(21) Appl. No.: 14/533,829

(22) Filed: Nov. 5, 2014

Related U.S. Application Data
(60) Provisional application No. 61/900,114, filed on Nov. 5, 2013.

(51) Int. Cl. G06F 19/00

(52) U.S. Cl. CPC G06F 19/323; G06F 19/3456

(57) ABSTRACT

A dual smart card system and method including a central exchange server which collects patient healthcare data from a plurality of healthcare providers and stores the data in its central data bases. Each healthcare provider and each patient has a smart card and both smart cards must be used when a provider prescribes a medication for the patient and when the pharmacy fills the prescription for the patient. The patients' medical information is stored on the patient's smart card and on the central database. The system makes the stored medical information immediately available to participating organizations and tracks the entire life cycle of the prescription and generates alerts for adverse drug events, fraud, and duplication.

### RELATED APPLICATIONS

This application claims priority to U.S. Provisional Application No. 61/900,114 filed Nov. 5, 2013 and titled “Dual Smart Card System and Method” which is hereby incorporated herein by reference in its entirety.

### FIELD

The field relates to electronic prescription systems, and more particularly to a medical information network that provides secure access to health information using a dual smart card system.

### BACKGROUND

Electronic health and medical record systems have limited capabilities to prevent e-prescribing fraud, or to provide enhanced patient safety and security. Existing systems only transmit information but do not interact with various healthcare providers such as pharmacies. Some such prior systems use cards such as smart cards to allow the patient or doctors to access the system database. These systems are typically closed systems which do not interact with providers existing systems thus requiring duplicative systems and double entry. Thus, there is a need for a dual smart card system that is compatible with many existing electronic health record systems and which enhances fraud prevention, patient safety and security.

### BRIEF DESCRIPTION OF THE DRAWINGS

FIG. 1 is a block diagram of an example of a central health information exchange, according to an example embodiment;

FIG. 2 is a detailed block diagram of a central health information exchange that may be deployed in accordance within the exchange of FIG. 1, according to an example embodiment;

FIG. 3 is a block diagram of an example central exchange that may be deployed within the system of FIG. 2 according to an example embodiment;

FIG. 4 is a block diagram of a machine form of an example computer system within which a set of instructions for causing the machine to perform any one or more of the methodologies discussed herein may be executed or stored.

### DETAILED DESCRIPTION

Example methods and systems for a dual smart card e-prescription system are described herein. In the following description, for purposes of explanation, numerous specific details are set forth in order to provide a thorough understanding of example embodiments. It will be evident, however, to one of ordinary skill in the art that embodiments of the invention may be practiced without these specific details.

The dual smart card system is an e-prescribing system which can be deployed as a standalone application or integrated with existing electronic medical records and prescription systems to identify beneficiary fraud, prevent e-prescribing fraud, and implement patient safety features related to medication management, thereby avoiding adverse patient events. This system can collect data in real-time and stores the data in a proprietary secure and HIPAA compliant data warehouse under control of the system manager. The system has in-built, multi-level security to which access is granted by a manager. The captured data is stored in a data center with a built-in back-up system and full operations continuity plan already in place. The system is designed to track all aspects of a patient's prescriptions including, but not limited to, allergies, drug interactions, and patient history and to provide notice to providers or pharmacies of dangers to the patient in prescribing certain medications, such as allergies or mediation interactions.

The e-prescribing dual smart card system substantially reduces prescription errors and fraud which occurs in e-prescribing. The system interoperates with existing healthcare systems, allowing integration into current operations. The dual smart card system captures information in real-time. For example, as soon as a single prescription is filled the prescriber can access this information and dual prescription fills are avoided. In addition, the prescriber can learn from the captured data how compliant the patient has been in taking the prescribed medication. This avoids potential adverse patient events. This two-way informational highway captures data from all participating physicians, thereby allowing physicians to coordinate their care for a single patient.

The dual smart card system allows participating organizations (clinics, hospitals, pharmacies, etc.) to share patient information, thus creating a Health Information Exchange (HIE) between participating health organizations. This allows patient data to be shared quickly and in a highly secure environment.

Patient information from different sources is stored in the proprietary central data center and consolidated under one unique master patient index file. This means that all participating organizations can access the latest patient information in real-time.

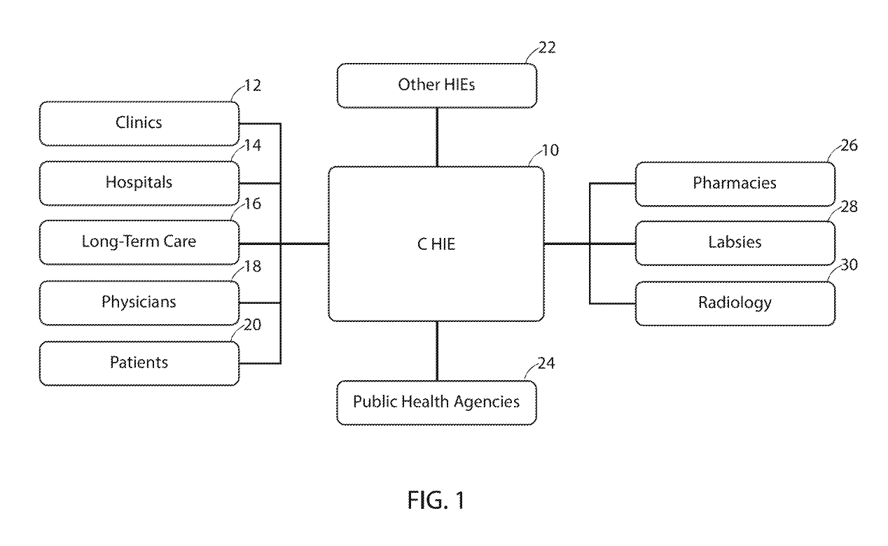

While the dual smart card system may be implemented as a stand-alone system, an example embodiment is shown in FIG. 1 integrated with a central health information exchange (HIE) 10. The Central Health Information Exchange 10 of FIG. 1 provides a secure system for participating health organizations to exchange health information. The exchange 10 connects and integrates providers 12, 14, 16, 18 pharmacies 26, public health agencies 24, other health information exchanges 22, medical labs 28, radiology 30, patients 20 and others involved in healthcare to collect data and create complete patient record in one central location in order to increase patient safety, eliminate fraud, lower costs and increase the quality of the healthcare provided.

Key features of the exchange 10 include: a dual smart card system that provides secure access to health information and payment coverage at the point of care; improved coordination and reconciliation of health information among participating health organizations through a unique medical information network; and alerts for adverse drug events (ADE), duplicate therapies, dosages and screening for potential drug abuse at the moment of prescribing through a Smart Alert software. The exchange 10 also decreases costs to healthcare systems resulting from inefficiencies, medical errors and incomplete patient information by providing a unique master patient index and access through the dual smart card. The exchange 10 also reduces the costs associated with medical fraud resulting from duplicate therapies, treatments, procedures and prescriptions, and from physician behavior, and increases participating health organizations operational efficiency by decreasing duplicative data input and reporting requirements, (e.g. public health reporting).

The exchange 10 provides core services including but not limited to registry and directory services, person and entity identification, record locator and search services, identity management, consent management, secure data transport, formulary eligibility verification and claims processing, patient portals/PHRs, and audit logging. In addition, the exchange 10 provides additional services including but not limited to a dual smart card authentication system for providers and patients, anti-fraud alerts, patient safety alerts, e-prescribing and e-dispensing, data de-identification, data mining and reporting, NY state I-stop integration (plus integration with other states), integration engine and EMR/EHR adapters, business intelligence, public health reporting, and gateway services (e.g. NHIN).

The exchange 10 as shown in FIG. 1 may be based on a cloud infrastructure with the exception of smart card reader software, used to read and write information to the smart card, and a SmartAlert application used to display patient safety information to providers. In a cloud-based architecture there are no special hardware requirements for participating health organizations, thus reducing implementation timescales and costs.

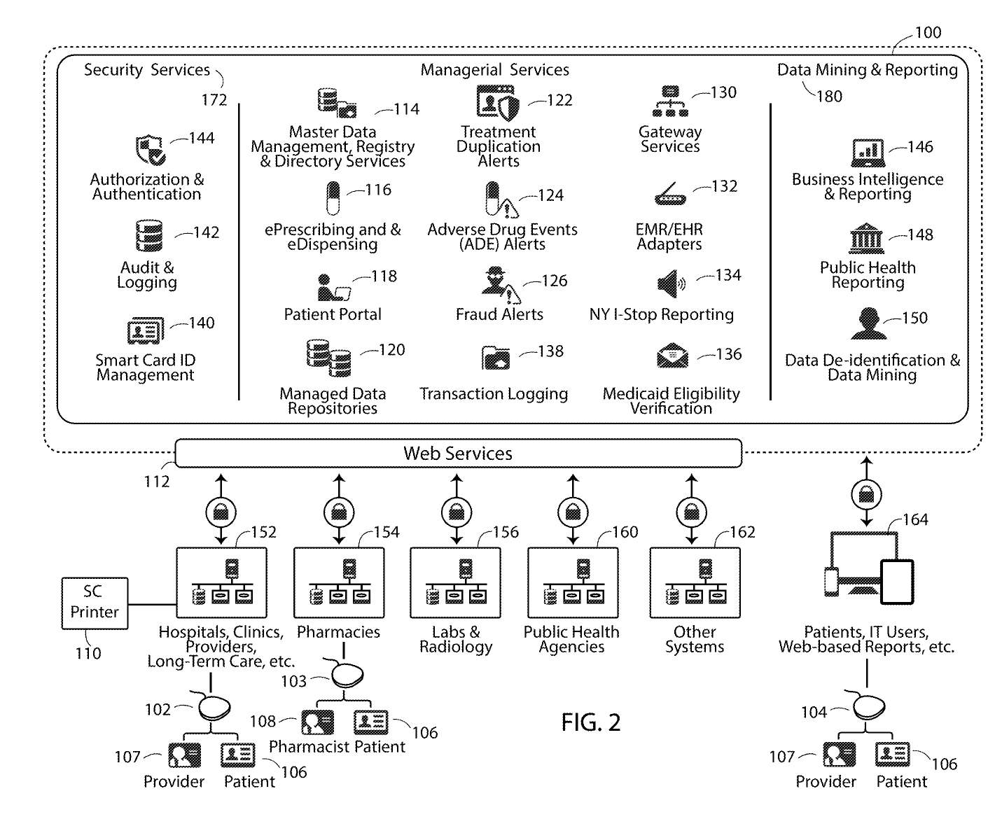

FIG. 2 is a detailed block diagram that illustrates an example of a central exchange data center 100 which includes servers, applications, services and databases needed for deployment. The central exchange of FIG. 2 includes a Smart Card Infrastructure which uses dual smart cards 106, 107, 108 for provider and patient identification, smart card readers 102, 103, 104, and a smart card printer 110 for use by participating health organizations that have permission to issue new smart cards. A SmartAlert application may display information from the exchange 100 and capture users' responses. Web services 112 communicate and exchange data with participating health organizations systems.

A wide range of services may be provided by the exchange 100 of FIG. 2 through a set of service modules including but not limited to Master Data Management, and Registry and Directory Services 114; ePrescribing and eDispensing Services using a Dual Smart Card System 116; Patient Portal of information 118, brought together from multiple sources; Managed Data Repositories 120 for wide range of clinical data from multiple sources; Treatment Duplication Alerts 122; Adverse Drug Events (ADE) Alerts 124; Fraud Alerts 126; Transaction Logging 128; Gateway Services 130; EMR/EHR Adapters 132 allowing multiple system interaction; NYS I-STOP Reporting 134; and Payment Eligibility Verification 136. Integration of multiple data sources provides a single access point to data pooled from the various electronic health systems.

In addition to a valid login, access to any of the Exchange 100 client applications, with the exception of the patient portal 118, use a valid smart card, a smart card reader, and a compatible web browser and operating system. Examples of suitable web browsers include Internet Explorer, Google Chrome, and Mozilla Firefox. The web browsers may for example support the Java Runtime Environment (JRE).

The exchange 100 may use any of a variety of suitable smart cards 106, 107, 108. Examples include PKI cards using MTCOS or JavaCard operating system; or cards in compliance with the IS07816 standard. For example, a card using a STM ST23YL48 chip, and Masktech MTCOS v2.1 operating system (contact interface, EEPROM memory), with MTCOS eHealth applets. The cards may use any suitable cryptography standard such as 3DES, AES, RSA and ECC, and may use an Enhanced NESCRYPT crypto-processor for public key cryptography with ISO 7816 standards compliance.

The exchange 100 providers may use any suitable smart card readers 102, 103, 104, for example, those compliant with ISO 7816 standards. The smart card readers have any suitable hardware configuration and may, for example, run on any processor system that supports a suitable operating system, for example. Win XP, Win Vista, Win 2008, Win 7, Win 8, Win 2003 x64, Win 2003 R2 x64, Win XP x64, Win Vista x64, Win 2008 x64, Win 2008 R2 x64, Win 7 x64, Win 8 x64, Win Server 2012 x64; Mac; Linux; etc.

A mobile smart card reader may also be used by providers along with a mobile operating system. Examples of suitable smart card readers include: iAuthenticate™ FIPS 201 (iOS only); ACR38U PocketMate II (Android only); and Tactivon™ mini (Android and iOS). Examples of suitable mobile operating systems include iOS; and Android.

Smart card printers 110 may be used by participating health organizations that have permission to issue new smart cards. The exchange smart card management modules work with any suitable smart card printer particularly those capable of printing PDF documents. Examples of smart card printers 110 that are suitable include Zebra ZXP Series 8; Magicard Prima 4 Uno; and Fargo HDP5000.

The exchange 100 may connect to other systems 162 such as other HIEs, public health networks (e.g. National Health Information Network) 160, and Lab and Radiology services 156 to allow users to search for patient information and documents such as lab and radiology results. The exchange 100 may interface with and exchange data with participating health organizations using a variety of methods including File Upload, and HL7 web services. The HL7 web services provide a number of benefits to the participating health organizations including a two-way information exchange, though not all providers may have fully enabled HL7 systems. In such cases the exchange 100 may allow participating health organizations to send data via a secure file upload application.

The exchange 100 may provide a range of web services 112 to enable participating health organizations to integrate their applications and exchange data. Participating organizations utilizing HL7 web services use specifications that describe how data must be structured and the appropriate trigger points, i.e. when the data should be sent to the exchange via the HL7 web services layer. In one example of integration where the EHR software interacts with the exchange, a provider may prescribe a new medication to a patient after the EHR vendor has added a new button (“Rx Check”) to their e-Prescribing module. This new button allows the EHR software to send all pertinent prescription information to the exchange 100 in order for checks to be performed. When the provider clicks on the “Rx Check” button, a number of things occur behind the scenes: 1) The EHR software sends the provider and patient details to the exchange; 2) Formulary and ADE checks as well as drug abuse and fraud attempt checks are performed; and 3) The EHR window is suspended and the exchange 100 response is displayed to the provider.

In this scenario, all information coming from the exchange 100 may be handled by a SmartAlert application. Since the EHR software is not handling the responses from the exchange 100 it cannot enforce the exchange 100 workflow. This means a provider can by-pass the exchange 100 checks and prescribe a medication that has adverse reactions without providing any valid reason unless this is a step that is already covered by the EHR software.

The main difference between this method and the Full API Integration, described below, is that in this case the information coming back from the exchange 100 is displayed to providers through the SmartAlert application. The SmartAlert application may be, for example, a program that runs on Windows platforms and is used to identify providers and patients, as well as handle any information coming from the exchange 100, e.g. a response to a medication check.

The SmartAlert application can also display to the authenticated and authorized users all the relevant information that the exchange 100 has for a patient including allergies, medication history, social history, formulary information, etc., participating health organizations may also have the option to receive HL7 information directly into their systems.

EHR vendors can also fully integrate their products with the exchange 100 using the API's provided so that the physician's workflow is not interrupted. This level of integration allows participating health organizations to realize the additional benefits that the exchange 100 can bring without adding extra workflows to physicians whose schedules are already very tight.

In order to integrate with the exchange 100, vendors may be provided with and comply with an Exchange Service Specification. This document may describe all the security and functional requirements necessary for the API integration. It also may provide a full description of all available services and APIs and how vendors can use those to query and exchange information with the exchange without ever leaving the context of their own software. This means that all the services provided by the exchange (anti-fraud alerts, patient safety alerts, public health reporting, etc.) can be delivered through the vendors' software packages without users (physicians, pharmacists, etc.) ever having to switch to another application.

For example, when adding a new medication to the patient's medical history, the EHR software will utilize the APIs to make a web service request to the exchange 100, passing all the relevant information such as provider id, patient id and the new medication details. The exchange 100 will fetch all relevant patient information from the Master Patient Index in database 120, such as the patient's active allergies and medication history, and perform a formulary and an Adverse Drug Events (ADE) check utilizing the new medication information received from the EHR software. The exchange may, for example, perform the following checks on new prescriptions: Duplicate therapies; Dosage checking; Drug-to-Allergy interactions; Drug-to-Drug interactions; Drug abuse and Fraud attempts.

The information resulting from those checks is sent back to the EHR software. The EHR software will decide the next step for the provider based on the response received from the exchange 100. If an adverse reaction resulted from the ADE check, the EHR software will then alert the doctor and ask the doctor to take one of the following actions: a) Review the patient's medications and make changes to the treatment based on formulary cover or adverse reactions; b) Enter reasons for ignoring the alert (e.g. “Benefits outweigh the risks”).

How this message is displayed is up to the EHR vendor. In addition to assisting providers in making better decisions concerning medications being prescribed, thereby minimizing the potential for adverse events or pharmacy call-backs, the exchange 100 can also automate public health reporting.

In the full API integration scenario, the exchange 100 may interact with providers within their EHR software. There is no need for separate applications and workflows. The EHR software handles all information and workflow requirements.

Some advantages of the Full API Integration for connecting and exchanging data with the exchange 100 are: 1) participating health organizations can carry on using their own systems (EMRs, pharmacy management systems, etc.) for their day-to-day tasks and, because of that, it has very little or no impact on their existing workflows; and 2) removes any need for manual keying, duplicating or manually uploading data to the exchange 100.

The web services is configured to accept HL7 data from different types of participating health organizations. Data coming from different participating health organizations is processed and stored in the exchange 100, databases. This data is available by the exchange 100 to the appropriate applications and services. Participating health organizations systems will generate HL7 messages, based on specific triggers, and send them to the exchange 100. These HL7 messages must comply with the specifications provided by the exchange 100. When the HL7 messages arrive at the exchange 100 via the HL7 web services, they are checked against the exchange 100's web services specifications and a response is sent back to the participating health organizations that generated the messages. Information between participating health organizations and the exchange 100 may be exchanged automatically and no manual intervention is required. Participating health organizations will also have the option to receive HL7 information directly into their systems.

The security infrastructure 172 is designed to guarantee that all information that flows across the exchange 100 is secure and can only be accessed by the appropriate users of the system. In this instance a “user” can mean a health professional, patient, public health agency, etc. The security infrastructure can be divided into three main areas, which are uniquely integrated; 1) Authentication Services; 2) Security Profiles; and 3) Smart Card Management which are integrated and provided by authorization module 144, an audit and logging module 142 and a smart card management module 140. The exchange 100 may be fully HIPPA compliant and provides five levels of security and authentication including secure methods for connecting and exchanging data.

By default, all communications between the exchange 100 and participating health organizations are done via transport layer security. The transport layer security uses cryptographic tools to create a secure Internet connection between the exchange 100 and participating health organizations. It may, for example, use X.509 certificates to verify the identity of the participating health organizations and to encrypt all data that is subsequently exchanged. As a consequence of choosing X.509 certificates, certificate authorities and a public key infrastructure are necessary to verify the relation between a certificate and its owner, as well as to generate, sign, and administer the validity of certificates. The same cryptographic infrastructure maybe used to issue individual certificates to users. These may be used in conjunction with the transport layer security to offer a second layer of encryption.

Role-based access control (RBAC) is a method of regulating access to information and resources. In the example exchange 100, access is based on the roles of the organization and individual users. In this context, access is the ability of an individual user to perform a specific task, such as view, create, or modify a file. Roles are defined according to organization, job competency, authority, and responsibility. In RBAC, roles can be easily created, changed, or discontinued as the needs of the exchange 100 evolve, without having to individually update the privileges for every organization or user.

The exchange 100 requires organizations and users to have active profiles in order to access information. This means that even if the user has a valid way of connecting to the exchange 100 the user will also be assigned to an organization, which has a valid and active profile, as well as having an active and valid profile himself.

The exchange 100 also requires every user to have valid credentials (username and password) in order to login into the system. Patients can also access their own health information via the Patient Portal 118. They will be required to have a valid username and password in order to login into the Patient Portal, a patient's smart card may or may not be required.

Smart cards may be used to establish the identity of exchange users and patients. In the case of patients, smart cards also play a vital role in: 1) Verifying patient identity, thus reducing fraud; 2) Helping to establish patient eligibility; 3) Locating the correct patient health record; and 4) Promoting interoperability by securely storing key patient demographics and health information.

The dual smart card system prevents healthcare fraud. In the dual smart card system both patient's and provider's (physician, hospital, pharmacy, nurse, etc.) smart card must be used in order to ensure the identity of both patient and health practitioner.

The dual smart card system requires that both the provider and the patient have an assigned, unique valid smart card and that both smart cards are used when prescribing new medication to a patient. As a prescription is created for a patient it is sent to the central data base 120 and is immediately available to all participating organizations. If a patient tries to go to a different doctor to get the same prescription, the system via the fraud alert module 126 alerts the doctor and the fraud attempt will be caught. This is a feature that is as a result of the ability to track each individual prescription through the system. The dual smart card system tracks and monitors the entire prescription life-cycle starting when the provider issues a new prescription, all the way through the pharmacy until it reaches the patient. The dual smart card system via the transaction logging module 128 also keeps an audit log file that details each time a prescription is viewed or modified, due to the ability to track individuals and prescriptions throughout their lifecycle.

The dual smart card system's reporting engine can be configured to monitor prescribing habits of providers in order to spot potential abuse and fraud attempts. For example, if a patient requests a certain medication above a certain threshold, the file can be flagged for review. Similarly, providers who write a certain level of a specific medication are flagged based on tracking of prescription data.

For example, pharmacists are required to login using their own smart card prior to filling prescriptions, thus closing the prescription loop and providing a full audit trail. In addition, providers can access the data to determine whether or not a prescription was actually filled, how many times it was filled, by which pharmacist, etc. The dual smart card system also allows providers and pharmacists to communicate in real-time, increasing efficiency and improving patient safety and levels of care. This two-way information flow increases efficiency and improves patient safety and levels of care.

Each person in the system (whether a provider, pharmacist or a patient) can only have one valid smart card at any one time. Smart cards need to be reported lost or stolen before a replacement can be issued. Old cards are automatically flagged as invalid when reported lost/stolen.

Before being able to create a new prescription, a provider must first login into the system using his/her valid smart card and then check-in the patient using the patient's smart card. During the process of creating a new prescription, the dual smart card system via the adverse drug event alert module 124 will perform adverse drug events checks and display any warnings or alerts to the prescriber, in real-time. Adverse drug event checks are designed to assist the prescriber in making decisions concerning medications to be prescribed, thereby minimizing the potential for adverse events or pharmacy call-backs. The dual smart card system, via the drug events module 124 and treatment duplication module 122 performs the following adverse event checks: 1) Duplicate therapies; 2) Dosage checking; 3) Drug-to-Allergy interactions; 4) Drug-to-Drug interactions. The ability to perform these checks using information from other prescribers is due to the ability to collect and track prescription data across the different organizations.

Once the prescription is ready, the provider can send it to the patient's preferred pharmacy. Pharmacists also have their own smart card which they use to login before they can dispense any of the prescriptions created by the dual smart card system. When a patient arrives at the pharmacy to collect a prescription, the pharmacist will first login to the system using their own smart card and then check-in the patient using the patient's smart card. Once the login procedure is complete the pharmacist is able to dispense medications to the checked-in patient. Once the pharmacist marks a prescription as filled it cannot be filled again. This prevents prescriptions being filled more than once, therefore preventing fraud.

In one example embodiment, the ability to track prescriptions, and stop prescriptions from being fulfilled more than once, prevents fraud. In this example, the patient visits a health care provider (e.g. doctor). The doctor's and patient's smartcards 106, 107 are used to login and authenticate the patient and doctor. During the process of creating a new prescription, the system performs the safety checks (drug interactions, allergies, duplicate therapy, etc.) via the modules 122, 124. Once the prescription is ready, it is sent electronically to the patient's preferred pharmacy. All changes to the patient's health record are saved in the master data base 120 as well as in the patient's smartcard 106.

In another example, the ability to perform safety checks on a prescription before it is sent to the pharmacy, enhances patient safety. In this example, the patient visits a pharmacy 154, and the pharmacist's and patient's smartcards 106, 108 are used to login and authenticate the patient and pharmacist. The details of the new prescription are displayed, and the full patient's details—prescription history, diagnosis, allergies, etc. are also available to the pharmacist. The pharmacist selects all medication that is being delivered to the patient and mark it as “filled”. The medication will be marked as “filled” in the master data base 120 as well as on the patient's card 106 so it can't be dispensed again.

As described, each time a patient visits a health care provider (e.g. a doctor), the changes in the health record (new prescriptions, diagnosis, etc.) will be saved in the central data base 120. Participating health care providers will have full visibility to the patient's electronic health when both the provider's and the patient's smart card have been inserted into the reader and been successfully authenticated against the central data base. The pharmacist will also have full visibility of the patient's active diagnoses, allergies and medication when both the pharmacist's and patient's card have been inserted into the reader and successfully authenticated against the central data base 120. The ability to prevent duplicate prescription filling is due to the ability to collect and track data across all connected organizations.

The dual smart card system illustrated may have a set of data exchange APIs and an HL7 integration engine that is capable of integrating and exchanging information in real-time with existing health information system such as electronic medical record and pharmacy management systems. The dual smart card system includes a flexible reporting engine 146 that can be used to create and run reports “on-the-fly” or at pre-defined scheduled intervals. Reports can be generated in various formats including PDF, CSV and MS Excel.

When new data arrives at the exchange 100 it is immediately de-identified and stored in the reporting database, which is used to run and generate reports. This adds extra performance and security to the dual smart card system. In addition, a flexible reporting solution can automatically populate and submit reports to specified recipients using an array of communication protocols like secure email, fax or electronic data transmission (HL7, XML, etc.).

The security and solution architecture will support changing requirements. Every active user and organization must have a valid security profile in order to login to the exchange 100. The Security Profiles services manager implements the Role-Based Access Control (RBAC) framework. The RBAC framework offers a very flexible way of managing roles and permissions and allows exchange 100 administrators to efficiently manage users at a large scale. A user can have multiple roles.

In order to make user management easier, the security services 172 can also be integrated with a connected organization's directory infrastructure (Active Directory, LDAP, etc.). This allows participating health organizations to keep using their own systems for managing user information and access rights which streamlines workflows, eliminates the need for duplicating user information and reduces security risks. For example, if a new employee joins the participating health organizations, the exchange 100 can, through the integration of the Security services 172, automatically detect and assign appropriate roles and permissions to the new employee. Similarly, when an employee leaves the participating health organizations, the exchange 100 may automatically revoke all access for the user thus eliminating unwanted access. Organizations that have integrated their directory infrastructure with the exchange 100 security services 172 can also use the option for single-sign-on.

The smart card management service allows participating health organizations with appropriate access rights to: 1) Issue new smart cards to user and patients; 2) Revoke smart cards; and 3) Report cards lost/stolen. Each card issued may have an expiry date. The exchange 100 also provides an automatic cancellation of smart cards when they reach expiry date. Patients can report cards lost/stolen via the Patient Portal, customer support service center or provider. The Smart Card Management services 140 also interface with the exchange's 100 business and reporting module 146 for billing and reporting purposes.

The exchange 100 stores and reconciles patient information from different sources like hospitals, clinics, pharmacies, public health organizations and government agencies. This information is used to provide a range of services from patient look-up to patient safety and fraud alerts. These services are available to connected organizations, providers and patients on desktop computers, laptops, tablets and mobile devices.

Accurate healthcare data is necessary to optimize core business processes across all segments of the healthcare spectrum. The exchange 100 provides a number of data management tools, registry and directory services to help solve data management challenges. These are: 1) enterprise master patient index; 2) master provider index; 3) entity registry; and 4) service registry.

An enterprise master patient index is a database within the data repositories 120 that may be used across healthcare organizations to maintain consistent, accurate and current demographic and essential medical data on patients. The patient is assigned a unique identifier that is used to refer to this patient across the enterprise. The objective is to ensure that each patient is represented only once across all participating health organizations.

The exchange 100 may provide a Master Provider Index for at least one of the following business processes: Provider Enrollment/Registration; Privacy and Security Provider Verification; Shared Provider Directories; Provider Contact Information for Care Coordination; Historical Contact Information for Fraud and Abuse Investigations; and, Provider Profiles for Health Plan Administrative Business Processes.

The Entity Registry within databases 120 provides a trusted registry of entities engaged in HIE transactions, and the systems that may be the senders or recipients of health information. The registry comprises part of a federated identity management system for HIE, and serves to inform parties and systems engaged in HIE transactions about the validity and authenticity of exchange partners.

The Service Registry within databases 120 may provide information about where to direct transactions intended for specific individuals or systems, such as providers or their specific EHRs, and how to formulate the transactions so that they can be correctly processed when received.

The exchange 100 ePrescribing and eDispensing module promotes medication safety, accuracy and efficiency in the prescribing process and encouraging meaningful use of the electronic health record (EHR). It may provide a true closed-loop system that integrates the entire medication prescribing and fulfillment process across all members of the exchange 100 using a single, integrated solution. Prescriptions entered via the exchange 100 ePrescription modules are available immediately to every member of the exchange 100 healthcare community.

Some key features of the ePrescription and eDispensing applications may be; 1) Prescriptions lifecycle tracking and monitoring; 2) Real-time patient safety checks increase patient safety. Checks include: duplicate therapies; dosage checking; drug-to-allergy interactions; drug-to-drug interactions; potential drug abuse; Real-time fraud alerts; 3) Patient smart cards to securely verify patients' identity and reduce prescription fraud; 4) Smart card technology to help protect patients' privacy, and promote continuity of care; 5) Fully HIPAA compliant, and I-STOP ready.

Using the secure Patient Portal 118, patients can have access to their clinical data within the exchange 100. The Patient Portal allows patients to: 1) access the health records via desktop computers and mobile devices allowing patients to access their health information at anytime and anywhere; 2) send, forward and reply to messages securely using the exchange 100 secure messaging capability; 3) facilitate the communication between patients and providers allowing patients to request a whole range of services such as new appointments, prescriptions and refills. These requests are sent to the appropriate provider saving time for both patients and providers; 4) add new information to their medical records in a secure and convenient fashion; and 5) update their demographic information such as address, telephone number, and formulary information quickly and easily.

Clinical data stored in the exchange 100 managed data repository 120 can be used for data exchange, querying and reporting. The system tracks and monitors the entire ordering life-cycle starting when the provider issues a new or treatment, all the way through to labs, radiology, etc. If a provider tries to order a duplicate treatment for a patient, it is detected and an alert is displayed to warn the provider.

During the process of creating a new prescription, the exchange 100 will perform adverse drug events checks and display any warnings or alerts to the prescriber, in real-time. Adverse drug event checks, assist the prescriber in making decisions concerning medications to be prescribed, thereby minimizing the potential for adverse events or pharmacy call-backs.

As a new order is created for prescription or treatment it is sent to the exchange 100 and is immediately available to all participating organizations. This means that if a patient tries to go to a different doctor to get the same prescription, or the provider tries to duplicate a test that has already been carried out, the system generates an alert to the provider based on the ability to track each individual order. The exchange 100 Audit and Logging service module 142 keeps an immutable audit of all transactions including login times, actions performed, information access, etc. The Gateway Services module 130 provide a means to connect and exchange information with other HIEs, public agencies, state health information networks and the National Health Information Network (NHIN). The exchange 100 hosts a library of EMR/EHR adapters 132 designed to reduce implementation costs and timescales.

A New York law known as the I-STOP law requires that the State create a registry which captures patient identifying information, prescription information, and payment information and which is easily accessible to providers and pharmacists. The exchange 100 may be configured to be is fully compliant with the I-STOP legislation.

The exchange 100 ability to share information, coupled with its unique dual smart card technology provides a very robust way for preventing and capturing prescription fraud: The exchange 100 requires that both the provider and the patient have a valid smart card and that both smart cards are used when prescribing new medication to a patient. The system tracks and monitors the entire ordering life-cycle starting when the provider issues a new prescription or treatment, all the way through to labs, radiology or the pharmacy. If a providers tries to order duplicate treatment for a patent, an alert in displayed, for example, via the Smart alert application. As a new order is created for prescription or treatment it is sent to the exchange 100 and is immediately available to all participating organizations. If a patient tries to go to a different doctor to get the same prescription, or the provider tries to duplicate a test that has already been carried out, the system generates an alert to the provider.

The exchange 100 can automatically submit information to public agencies on behalf of program organizations thus increasing operational efficiency and reducing administration costs. Medicaid services are delivered through a wide network of providers, consisting of individual providers all the way through to very large enterprises such as large hospitals and pharmacy chains. This network of providers could be classified into one of three main groups based on their system's level of connectivity and interoperability: 1) paper based providers; 2) disconnected providers; and 3) HL7 enabled providers.

Providers running on paper-based system (i.e. all records still paper based) will be able to login and use the exchange 100 clinical tools. This option will allow providers to: 1) Use the Dual Smart Card Authentication to login and authenticate Medicaid smartcard holders; 2) Create ePrescriptions and new orders using the exchange 100 clinical tools; 3) Receive patient safety and treatment duplication alerts.

Some providers may have an electronic system but, camiot connect their systems to the exchange 100. Their system, for example, may not have the ability to interface using HL7, CCD, CCR or other supported data exchanging formats. These providers have two options for integration with the exchange 100.

In one configuration, they may use the exchange 100 clinical tools which will allow providers to: 1) use the dual smart card authentication to login and authenticate Medicaid smartcard holders; 2) create ePrescriptions and new orders using the exchange 100's clinical tools; and 3) receive patient safety and treatment duplication alerts

In an alternative, providers can use a combination of the SmartAlert and File Upload applications to be able to: 1) Use the dual smart card authentication to login and authenticate Medicaid smartcard holders; and 2) Send information to the exchange 100.

Providers who do have HL7-enabled systems can connect to the exchange 100 to exchange data automatically under various configurations. For example providers may use the exchange 100 clinical tools to allow the providers to: 1) use the dual smart card authentication to login and authenticate Medicaid smartcard holders; 2) create ePrescriptions and new orders using the exchange 100 clinical tools; 3) receive patient safety and treatment duplication alerts.

If replacing their systems with exchange 100's clinical application is not an option, providers can use a combination of the SmartAlert and File Upload applications to be able to: 1) use the dual smart card authentication to login and authenticate Medicaid smartcard holders; and 2) send information to the exchange 100.

Providers can have their systems configured to send automatic HL7 updates whenever a patient record is created or modified. This eliminates changes to users' workflows and reduces training needs. This option will allow providers to: 1) Use the dual smart card authentication to login and authenticate Medicaid smartcard holders; 2) automatically send information updates to the exchange 100; and 3) receive patient safety and treatment duplication alerts.

In order to help participating health organizations to integrate their own systems, the exchange 100 provides the necessary tools for developing, testing, deploying, and HL7 interfaces. Using the exchange integration engine new interfaces can be created and deployed. The exchange 100 supports numerous transfer protocols used across the healthcare industry, including but not limited to: MLLP; HTTP/HTTPS; Database; Email; PDF; JMS; TCP/1P; Web Services (SOAP); File System; (S)FTP; RTF; and DICOM. Custom connectors can also be written to support new protocols if needed.

The exchange 100 reporting module 146, 148, 150 allows authenticated and authorized users to create and run reports “on-the-fly” or at pre-defined scheduled intervals. Reports can be generated in various formats including PDF, CSV and MS Excel.

When new data arrives at the exchange 100 it is immediately de-identified and stored in a reporting database within the databases 120, which is used to run and generate reports. This adds extra performance and security to the exchange 100. In addition, the flexible reporting solution can automatically populate and submit reports to public agencies and specified recipients using an array of communication protocols like secure email, fax or electronic data transmission (HL7, XML, etc.). The Data Mining and Reporting modules 146, 148, 150 can produce a wide range of reports including, for example: Public Health Reporting (NY I-STOP); Data warehouse, data analytics/queries and business intelligence; Performance management; Population monitoring and predictive profiling; Care gap identification; Care and disease management; and Public health monitoring and analysis.

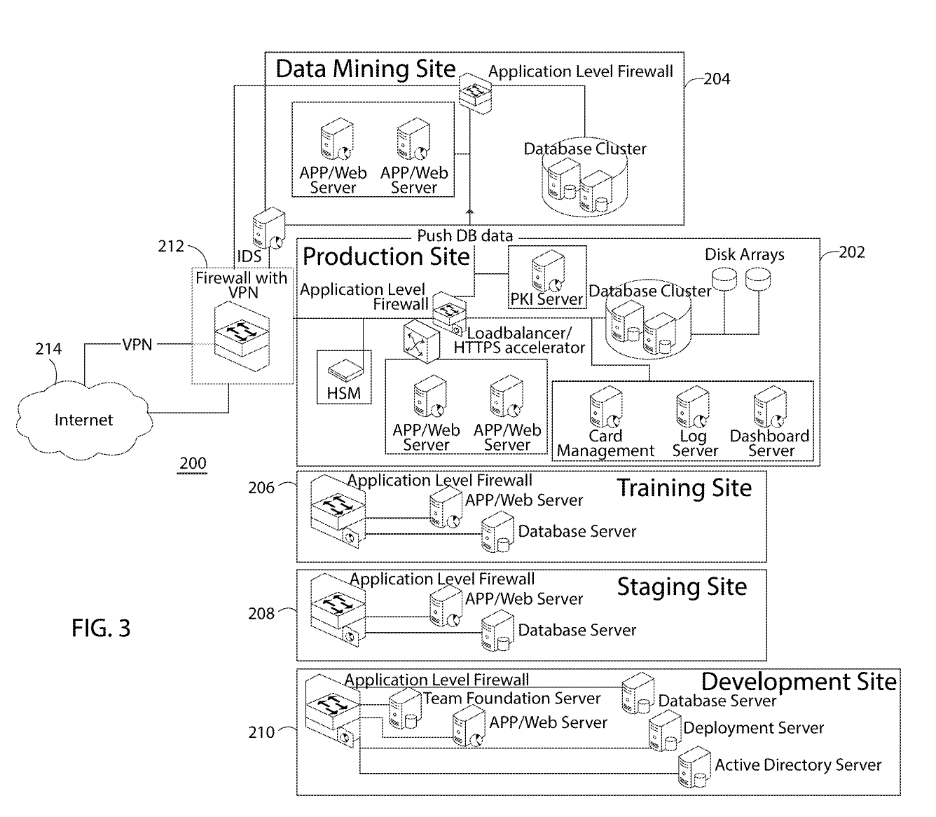

The one embodiment a central exchange 100 may have five different environments, each serving different functions within the overall architecture. FIG. 3 illustrates an example embodiment of such a central exchange 200 with five environments. The five environments are: 1) Production 202, which is an example of the live site used by all participating health organizations and patients including a set of servers as shown; 2) Data Mining and Reporting 204 which is an environment that holds a copy of all live data and may be used for data mining and reporting and all data is de-identified before being added to the this environment; 3) Training 206 which is used for user training sessions, and data is automatically refreshed at the end of each session; 4) Staging 205 which is used for testing new functionality and bug-fixes before it is migrated to the Production environment; and 5) Development 210 which is used to develop new functionality. These are implemented as shown using a set of servers and database clusters. A firewall 212 couples each environment through the interne 214 to participating users.

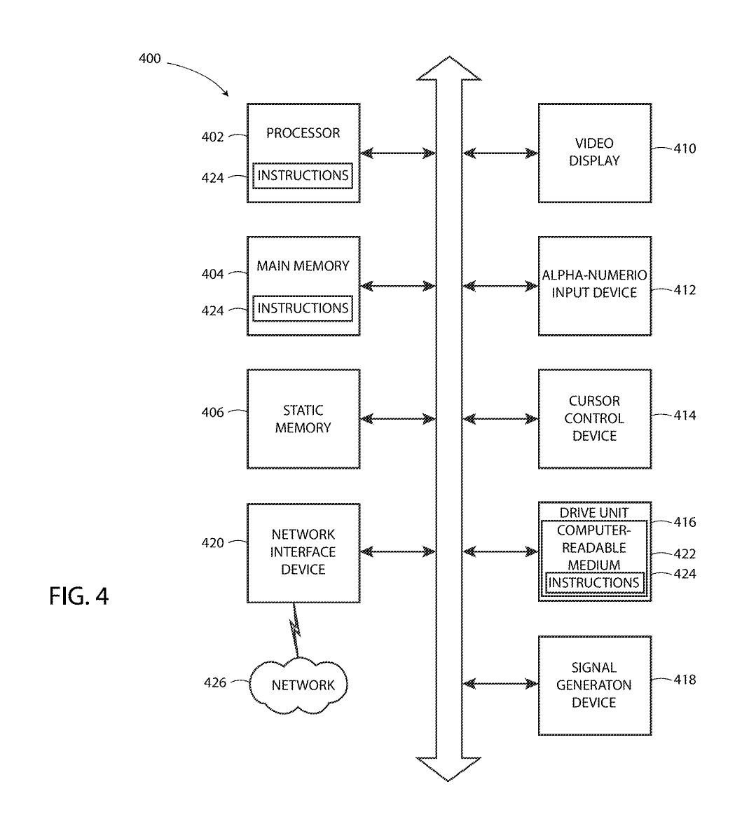

FIG. 4 shows a block diagram of a machine in the example form of a computer system 400 within which a set of instructions may be executed causing the machine to perform any one or more of the methods, processes, operations, or methodologies discussed herein. The mobile electronic device, the exchanges 100, 200 servers and other processing systems, the health care provider sites, patient sites, and/other processor systems may include the functionality of the one or more computer systems 400.

In an example embodiment, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, mobile device, a gaming device, a set-top box (STB), a Personal Digital Assistant (PDA), a cellular telephone, a web appliance, a network router, switch or bridge, gateway, firewall or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 may include a processor 402 (e.g., a central processing unit (CPU), a graphics processing unit (GPU) or both), a main memory 404 and a static memory 406, which communicate with each other via a bus 408. The computer system 400 further may include a video display unit 410 (e.g., a liquid crystal display (LCD) plasma, or a cathode ray tube (CRT)). The computer system 400 also may include an alphanumeric input device 412 (e.g., a keyboard), a cursor control device 414 (e.g., a mouse), a drive unit 416, a signal generation device 418 (e.g., a speaker) and a network interface device 420.

The drive unit 416 may include a computer-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting computer-readable media. The software 424 may further be transmitted or received over a network 426 via the network interface device 420.

While the computer-readable medium 422 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, transitory and non-transitory media. Examples of non-transitory media include but are not limited to solid-state memories, optical media, and magnetic media. In some embodiments, the computer-readable medium is a non-transitory computer-readable medium.

The term “based on” or using, as used herein, reflects an open-ended term that can reflect others elements beyond those explicitly recited. Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different embodiments of which there are many possible permutations. In another example embodiment, a computerized system includes a processor with associated memory coupled to a communication network module.

Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. The methods described may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A dual smart card system comprising:
a central health exchange having at least one server and database storage;
a communications network coupled to the central health exchange and to a plurality of healthcare provider sites each of which have a smart card reader and an assigned unique smart card assigned to each of a plurality of healthcare providers;
the central health exchange configured to collect patient healthcare data from the plurality of health care provider sites and to store the patient healthcare data in the data base storage, wherein each patient of a plurality of patients has an assigned unique patient smart card, having patient healthcare and identification data stored thereon, and the central health exchange configured to perform authentication of a provider of the plurality of providers and a patient of the plurality of patients to allow the provider to issue an electronic prescription in response to data read from the patient smart card and from the provider smart card by the smart card reader and transmitted to the central health exchange.

2. The dual smart card system of claim 1 further comprising the central health exchange authorizing a pharmacy site to fill the electronic prescription in response to data read from the patient smart card and from an assigned unique pharmacist smart card and transmitted to the central health exchange.

3. The dual smart card system of claim 1 wherein the data on the smart cards is encrypted and data transmitted to the central health exchange is transmitted in encrypted form.

4. The dual smart card system of claim 1 wherein information regarding prescribing habits of the healthcare provider sites is stored and monitored by the central health exchange server.

5. The dual smart card system of claim 2 wherein the central health exchange prevents prescriptions from being filled by more than one pharmacy.

6. The dual smart card system of claim 1 wherein the central health exchange checks patient healthcare data and the electronic prescription to detect adverse events and generates an alert before authorizing the electronic prescription.

7. The dual smart card system of claim 1 wherein the healthcare data collected by the central health exchange is made immediately available to the plurality of provider sites.

8. The dual smart card system of claim 6 wherein the central health exchange queries whether the provider desires to change the prescription in response to the adverse event alert.

9. The dual smart card system of claim 1 wherein the central health exchange and provider sites use a HL7 standard to convert to the provider sites.

10. The dual smart card system of claim 1 wherein the healthcare provider sites comprise mobile devices of healthcare providers.

11. A method of providing secure e-prescriptions using dual smart cards, comprising:
a central health exchange server collecting patient healthcare data from a plurality of diverse healthcare provider sites of a plurality of healthcare providers each having a smart card reader and each provider having an assigned unique smart card;
the central health exchange server storing the patent healthcare data in a data based storage device;
the central healthcare exchange server assigning a unique patient smart card to each patient of a plurality of patients, each unique patient smart card having patient healthcare and identification data stored thereon;
the central health exchange authenticating a provider of the plurality of providers and a patient of the plurality of patients to allow the provider to issue an electronic prescription in response to smart card data read from the patient smart card and from the provider smart card by a smart card reader and transmitted to the central health exchange server; and,
the central health exchange receiving the electronic prescription and the smart card data read from the patient smart card and from the provider smart card.

12. The method of claim 11 further comprising the central health exchange server authorizing a pharmacy site to fill the electronic prescription in response to data read from the patient smart card and from an assigned unique pharmacist smart card.

13. The method of claim 11 wherein the data on the smart card is encrypted and data transmitted to the central health exchange is transmitted in encrypted form.

14. The method of claim 11 wherein information regarding prescribing habits of the plurality of healthcare providers is stored and monitored by the central health exchange server.

15. The method of claim 12 wherein the central health exchange server prevents prescriptions from being filled by more than one pharmacy.

16. The method of claim 11 wherein the central health exchange checks patient healthcare data and the electronic prescription to detect adverse events and generates an alert before authorizing the electronic prescription.

17. The method of claim 11 wherein the patient healthcare data collected by the central health exchange is made immediately available to the plurality of healthcare provider sites.

18. The method of claim 16 wherein the central health exchange server queries whether the provider desires to change the prescription in response to the adverse event alert.

19. The method of claim 11 wherein the central health exchange and provider sites use a HL7 standard to communicate with the healthcare provider sites.

20. The method of claim 11 wherein the healthcare provider sites comprise mobile devices of healthcare providers.
